(19) United States
(12) Patent Application Publication
(10) Pub. No.: US 2026/0114490 A1
(43) Pub. Date: Apr. 30, 2026

(54) OIL DISPENSING SYSTEM FOR A POPCORN MACHINE

(71) Applicant: Gold Medal Products Co., Cincinnati, OH (US)

(72) Inventor: Joseph L. Morin, West Chester, OH (US)

(21) Appl. No.: 19/375,507

(22) Filed: Oct. 31, 2025

Related U.S. Application Data
(60) Provisional application No. 63/714,175, filed on Oct. 31, 2024.

(51) Int. Cl. A23P 20/18; A23L 7/174; A23P 20/10

(52) U.S. Cl. CPC A23P 20/18; A23L 7/174; A23P 20/11

(57) ABSTRACT

An oil distribution system for a food machine includes a first and second pump, a fluid junction, and a selector switch. The first pump includes first inlet and outlet ports. The second pump includes second inlet and outlet ports. The fluid junction includes first and second input ports and an output port. The first input port is fluidly coupled to the first outlet port. The second input port is fluidly coupled to the second outlet port. The output port is in fluid communication with the first input port and the second input port. The selector switch is configured to selectively activate either the first pump or the second pump. Activation of the first pump directs oil from the first outlet port to the first input port of the fluid junction. Activation of the second pump directs oil from the second outlet port to the second input port.

### REFERENCE TO RELATED APPLICATION

This application claims priority of U.S. provisional patent application Serial No. 63/714,175, entitled OIL DISPENSING SYSTEM FOR POPCORN MACHINE, filed October 31, 2024, and hereby incorporates this patent application by reference herein in its entirety.

### TECHNICAL FIELD

Embodiments of the technology relate, in general, to systems, an oil dispensing system that dispenses cooking oil to a kettle of a popcorn machine.

### BACKGROUND

Commercial popcorn poppers, particularly those employed in high-volume venues such as movie theaters and sports arenas, conventionally utilize automated oil dispensing systems to deliver popping oil to their kettles. These systems typically employ a single pump to transfer oil from a storage reservoir to the popping kettle.

### BRIEF DESCRIPTION OF THE DRAWINGS

FIG. 1 is a front perspective view depicting a popcorn machine;

FIG. 2 is a rear perspective view of the popcorn machine of FIG. 1 but with a rear window removed for clarity of illustration;

FIG. 3 is an enlarged view of a dispensing tube of the popcorn machine of FIG. 1;

FIG. 4 is a front perspective view of a rack and a pump assembly shown apart from the popcorn machine of FIG. 1;

FIG. 5 is an enlarged perspective view of the pump assembly of FIG. 4;

FIG. 6 is a perspective view of the rack and pump assembly of FIG. 4 in association with various fluid tubes;

FIG. 7 is a cross sectional view taken along the line 7-7 of FIG. 2; and

FIG. 8 is a perspective view of a fluid junction in association with the dispensing tube of FIG. 3 and a pair of the fluid tubes of FIG. 6.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Described herein are one or more example embodiments of a kettle-style popcorn machine that includes a kettle and an oil dispensing system that automatically injects oil into the kettle to facilitate the popping raw popcorn kernels within the kettle. The oil dispensing system can include two separate oil containers, which are illustrated as bag-in-box type containers, and that each have a dedicated pump associated therewith that can selectively dispense the oil from either of the oil containers. A control interface, such as a rocker switch, can allow a user to select which pump, and thus which oil reservoir, is to provide oil to the kettle. In some embodiments, different types of oil can be housed in the different oil containers which can allow a user to select between the different oils when popping different types of popcorn (e.g., canola oil for theater-type popcorn and coconut oil for gourmet-type popcorn). In other embodiments, the same oil can be housed in both of the oil containers to allow for a user to easily switch from a depleted oil container to full oil container thus enabling the depleted oil container to be replaced without taking the popcorn machine out of service.

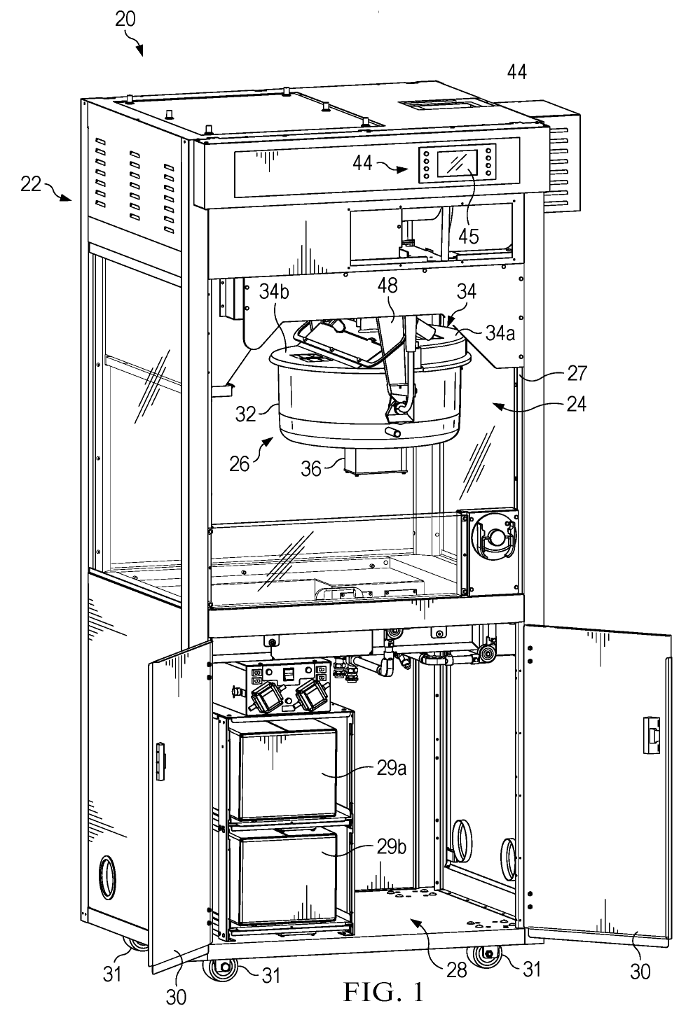

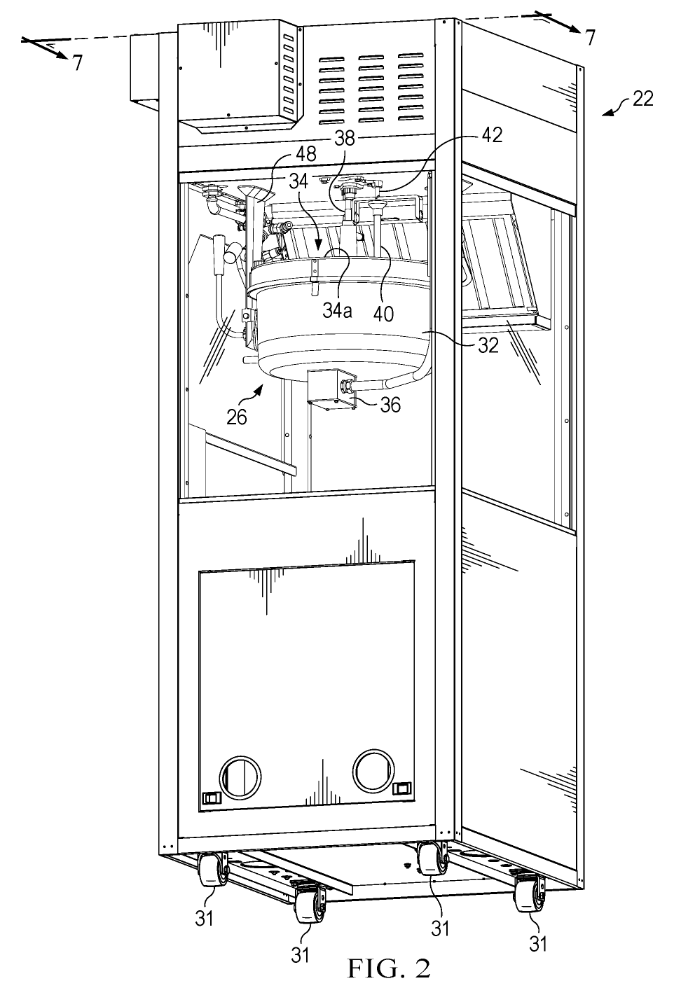

Embodiments are hereinafter described in detail in connection with the views and examples of FIGS. 1-8, wherein like numbers indicate the same or corresponding elements throughout the views. A popcorn dispensing machine 20 (hereinafter “popcorn machine 20”) that facilitates dispensation of popcorn to a consumer is generally depicted in FIGS. 1 and 2. The popcorn machine 20 can include a housing 22 that defines a popping chamber 24. A kettle 26 can be disposed in the popping chamber 24 for popping popcorn. The housing 22 can define an access opening 27 that allows a user to access the popping chamber 24 to retrieve popcorn that is dispensed into the popping chamber 24 and/or gain access to the kettle 26. The housing 22 can include a storage compartment 28 disposed beneath the popping chamber 24 for storing first and second oil containers 29a, 29b (collectively “the oil containers”) that dispense oil to the kettle 26 during the popcorn popping process. The storage compartment 28 can be selectively concealed by a pair of doors 30. The housing 22 can be supported by a plurality of casters 31 that facilitate mobility and positioning of the popcorn machine 20.

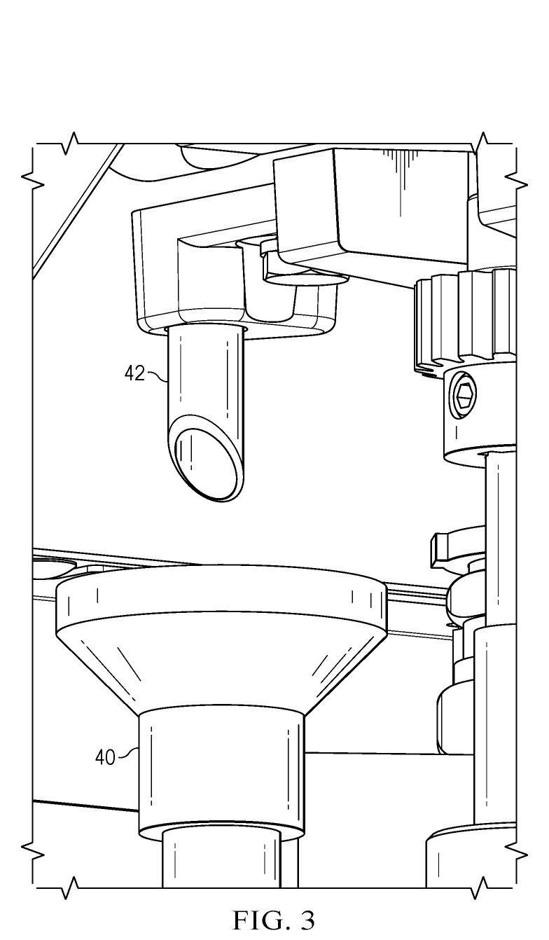

The kettle 26 can include a kettle bowl 32 and a lid 34 that has a fixed panel 34a and a pivotable panel 34b that can be selectively pivoted relative to the fixed panel 34a to selectively open the kettle bowl 32 (e.g., for dispensing popcorn and/or to gain access to the interior of the kettle bowl 32). A heater 36 can be provided along a bottom of the kettle bowl 32 that generates enough heat to pop the popcorn contained in the kettle bowl 32. The kettle 26 can include an internal stirrer (not shown) that can rotate relative to the kettle bowl 32 to agitate the popcorn kernels during popping. The stirrer can be operably connected to a motor (not shown) via a shaft 38 that facilitates rotation of the stirrer. A funnel 40 can extend upwardly from the fixed panel 34a of the lid 34 and can provide a pathway therethrough that allows oil to be introduced into the kettle 26. As illustrated in FIG. 3, a dispensation tube 42 can be provided above, and spaced from, the funnel 40 and can selectively dispense oil into the funnel 40, as will be described in further detail below.

The popcorn machine 20 can include a control panel 44 through which a user can interact with the popcorn machine 20. The control panel 44 can include a display 45 that provides visual feedback and operational information about the popcorn machine 20. The control panel 44 can receive inputs from the user and can provide operational information about the popcorn machine 20 via the display 45. Through the control panel 44, a user can initiate the popping process, monitor the temperature of the kettle 26 via the display 45, adjust timing parameters for oil dispensation, and receive status notifications regarding the completion of each popping cycle on the display 45. The display 45 can also show diagnostic information such as oil levels in the containers 29a, 29b, maintenance alerts, and operational statistics to assist with machine management and troubleshooting.

The control panel 44 can include pushbuttons that allow for user interaction to facilitate control of the popping process. Additionally or alternatively, the display 45 can be a touchscreen that allows for user interaction by enabling users to interact directly with displayed controls and menus. The control panel 44 is shown to be mounted on the housing 22 above the popping chamber 24 but can alternatively be provided in any of a variety of suitable alternative locations. The control panel 44 can additionally or alternatively be implemented as a remote controller (e.g., on a standalone controller, smartphone or other remote computing device) that allows the popcorn machine 20 to be controlled remotely.

The control panel 44 can include, or can be associated with, a controller (not shown) that controls the operation of the heater 36, operation the motor, and/or the dispensation of oil into the kettle bowl 32 as a function of user inputs to the control panel 44. The controller can be embodied as any type of processor capable of performing the functions described herein. For example, the controller may be embodied as a single or multi-core processor, a digital signal processor, a microcontroller, a general purpose central processing unit (CPU), a reduced instruction set computer (RISC) processor, a processor having a pipeline, a complex instruction set computer (CISC) processor, an application specific integrated circuit (ASIC), a programmable logic device (PLD), a field programmable gate array (FPGA), or other processor or processing/controlling circuit or controller.

To initiate a popcorn popping process, a user can first initialize the popcorn machine 20 at the control panel 44 (e.g., by pressing a ‘start’ button) which can cause the heater 36 to be activated. Once the kettle bowl 32 has been heated to a desired temperature for popping popcorn, the user can be notified at the display 45 to add unpopped corn kernels into the kettle bowl 32 (e.g., via the pivotable panel 34b). Once the kernels are loaded into the kettle bowl 32, the user can confirm that the kettle bowl 32 is loaded via the control panel 44. Oil can then be automatically dispensed from the dispensation tube 42 through the funnel 40 and into the kettle bowl 32 and the motor can be activated to rotate the stirrer. As the kettle bowl 32 fills with popcorn, excess popcorn can push the pivotable panel 34b open to allow the popcorn to be collected on a tray (not shown) located in the popping chamber 24. During the popping process, the controller can monitor various parameters such as temperature, timing, and stirring activity to track the progress of the popcorn production. As the popping activity diminishes and approaches completion, the controller can evaluate these indicators to determine when the popping cycle has finished. Once the controller detects that the popping process is complete, it can automatically notify the user through the display 45, which may show a completion message, change color, or provide other visual or audible alerts to indicate that the batch of popcorn is ready for collection.

The kettle 26 can be suspended from a pair of hooks 48 to allow for manual tipping of the kettle 26 when needed. For example, after the automatic popping process is complete, the user can manually pivot the kettle 26 about the hooks 48 to empty any remaining popcorn from the kettle bowl 32 through the pivotable panel 34b and onto the tray below. The dispensation tube 42 and the funnel 40 can be spaced from each other to allow the kettle 26 and the funnel 40 to be pivoted (e.g., moved) relative to the dispensation tube 42. This configuration enables the dispensation tube 42 to remain in a fixed position above the popping chamber 24 while the funnel 40 pivots together with the kettle 26 for emptying popcorn. The funnel 40 and kettle 26 can then be returned to their home position beneath the dispensation tube 42 for subsequent oil dispensing operations.

The fluid junction 108 can dispense pressurized oil to the funnel 40. Once the pressurized oil exits the dispensation tube 42 and enters the funnel 40, it is no longer pressurized at the funnel 40 and thus is gravity fed through funnel 40 and into the kettle bowl 32 below. This configuration can provide several benefits, including consistent oil delivery regardless of the kettle's position during operation, reduced risk of oil splashing or uncontrolled dispensing that could occur with high-pressure direct injection, and simplified funnel design that relies on gravity flow rather than requiring pressure-resistant sealing mechanisms. In some aspects, this transition can also allow for more precise control of oil flow rates and volumes, as the pressurized delivery ensures reliable dispensation of oil into the funnel 40 while the gravity-fed oil through the funnel 40 provides consistent, controlled fluid flow into the kettle bowl 32.

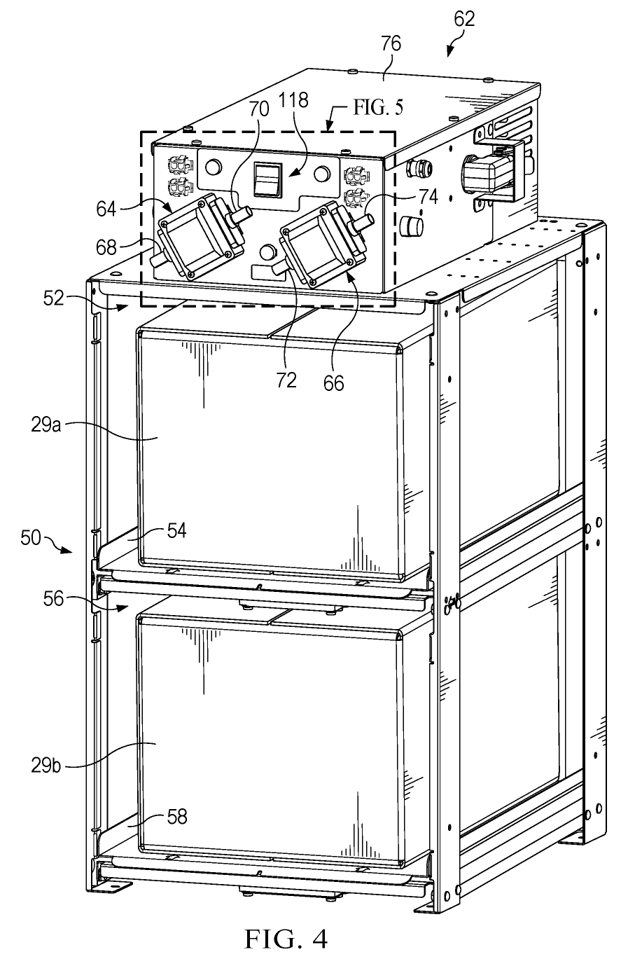

Referring now to FIG. 4, a support rack 50 is shown that is configured to support the oil containers 29a, 29b. The support rack 50 can include an upper compartment 52 that has an upper shelf 54 and a lower compartment 56 that has a lower shelf 58. The oil containers 29a, 29b can be provided in separate ones of the upper compartment 52 and the lower compartment 56 and supported by the upper shelf 54 or the lower shelf 58, respectively. The upper shelf 54 and the lower shelf 58 can be slightly angled or inclined to facilitate proper drainage of oil from the oil containers 29a, 29b. In some aspects, this angled configuration allows the oil to naturally collect at one end of each of the oil containers 29a, 29b, which can help ensure more complete dispensation of the oil contents.

A spigot or other dispensing fixture can be provided at the lower end of the oil containers 29a, 29b to facilitate the dispensation of oil from the containers to the kettle 26. This lower positioning of the dispensing fixture allows gravity to naturally direct the oil toward the spigot. The configuration ensures that substantially all of the oil within the containers 29a, 29b can be effectively dispensed through the spigot without leaving significant residual oil in the oil containers 29a, 29b. In one embodiment, the oil containers 29a, 29b can be bag-in-box type containers that have an outer rigid box, typically made of carboard, that houses a flexible bag that contains the oil. The bag-in-box containers can be provided with on-board spigots that allow for quick and convenient attachment when installing or replacing the oil containers 29a, 29b.

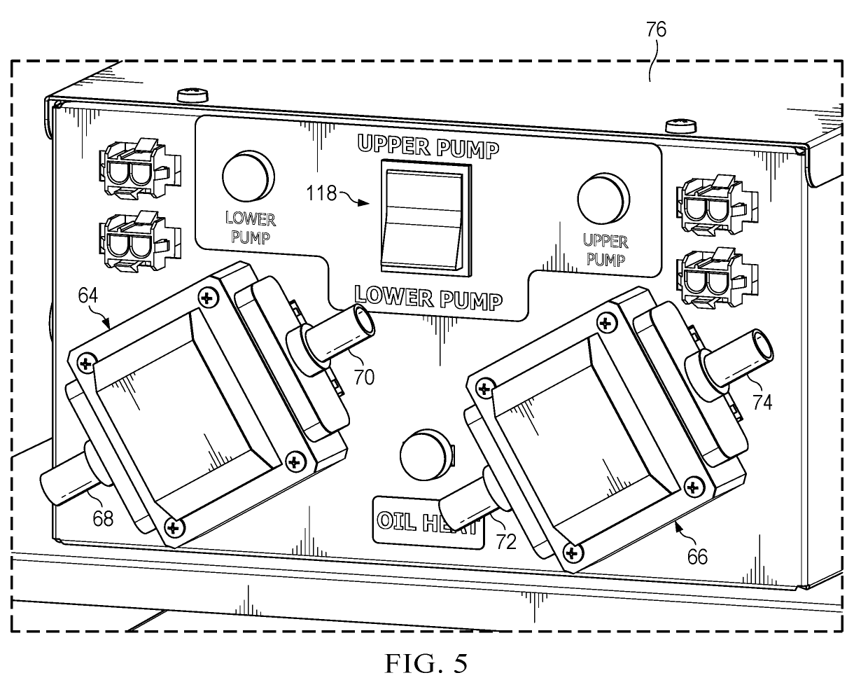

A pump assembly 62, which can form part of an oil distribution system, can be mounted on the top of the support rack 50 and configured to facilitate pumping of the oil from the oil containers 29a, 29b to the kettle 26. As illustrated in FIGS. 4 and 5, the pump assembly 62 can include a first pump 64 and a second pump 66 that serve as dedicated pumps for the first and second oil containers 29a, 29b, respectively. In other words, the first pump 64 can be solely responsible for pumping oil from the first oil container 29a and the second pump 66 can be solely responsible for pumping oil from the second oil container 29b. As illustrated in FIG. 5, the first pump 64 can include an inlet port 68 and an outlet port 70 such that, during operation of the first pump 64, oil is drawn into the inlet port 68 and is dispensed from the outlet port 70. The second pump 66 can include an inlet port 72 and an outlet port 74 such that, during operation of the second pump 66, oil is drawn into the inlet port 72 and is dispensed from the outlet port 74. The first and second pumps 64, 66 can be a diaphragm pump, a solenoid pump, or any of a variety of other suitable pump arrangements. The pump assembly 62 can also include a housing 76 and a dedicated electronics package (not shown) that is housed within the housing 76 for powering and controlling the first and second pumps 64, 66, as will be described further below.

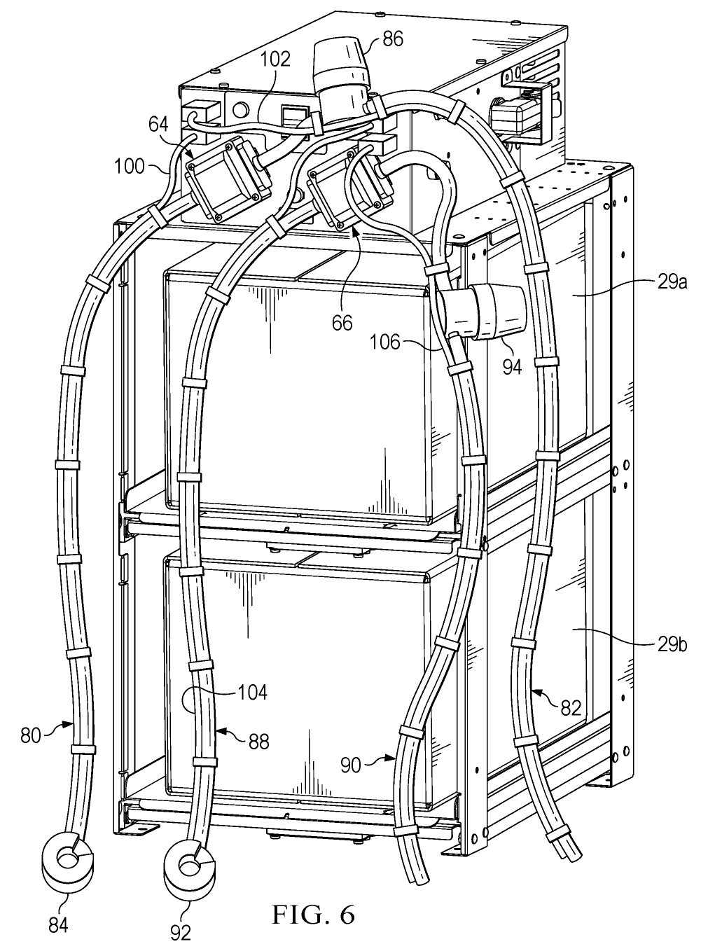

Referring now to FIG. 6, the first pump 64 can be fluidly coupled to a fluid inlet line 80 and a fluid outlet line 82 that cooperate to route oil from the first oil container 29a to the kettle 26. The fluid inlet line 80 can be fluidly coupled at one end to the inlet port 68 and at the other end to the first oil container 29a. The end of the fluid inlet line 80 that is coupled with the first oil container 29a can include a coupler 84 that is configured for releasable coupling with the dispensing fixture of the first oil container 29a. As such, the coupler 84 can be easily reconnected with a replacement oil container when the first oil container 29a is depleted. The fluid outlet line 82 can be fluidly coupled at one end to the outlet port 70 and at the other end to the dispensation tube 42. The fluid outlet line 82 can include a filter 86 that dampens the impulses in the oil from the first pump 64 to encourage a more consistent flow of oil into the kettle 26.

The second pump 66 can be fluidly coupled to a fluid inlet line 88 and a fluid outlet line 90 that cooperate to route oil from the second oil container 29b to the kettle 26. The fluid inlet line 88 can be fluidly coupled at one end to the inlet port 72 and at the other end to the second oil container 29b. The end of the fluid inlet line 88 that is coupled with the second oil container 29b can include a coupler 92 that is similar to the coupler 84. The fluid outlet line 90 can be fluidly coupled at one end to the outlet port 74 and at the other end to the dispensation tube 42. The fluid outlet line 90 can include a filter 94 that is similar to the filter 86.

Each of the fluid inlet line 80, the fluid outlet line 82, the fluid inlet line 88, and the fluid outlet line 90 (collectively the “fluid lines”) can be formed of a tube or other similar conduit that can facilitate the routing of fluid therethrough. The fluid lines 80, 82, 88, 90 can be formed of various materials suitable for food-grade applications and oil transport. In some aspects, the fluid lines 80, 82, 88, 90 can be constructed from flexible tubing materials such as food-grade silicone, polyurethane, or thermoplastic elastomer that can withstand the temperatures and chemical properties of cooking oils. The fluid lines 80, 82, 88, 90 can also be formed from rigid materials such as stainless steel tubing or food-grade plastic conduits in applications where structural support or specific routing requirements are desired. In some cases, the fluid lines 80, 82, 88, 90 can incorporate a combination of flexible and rigid sections to optimize both functionality and installation convenience.

In one embodiment, each of the fluid lines 80, 82, 88, 90 can be heated by respective thermal wires 100, 102, 104, 106 that generate enough heat to prevent the oil from coagulating inside of the fluid lines 80, 82, 88, 90. The thermal wires 100, 102, 104, 106 can be resistive heating elements that are positioned along or within the walls of the fluid lines 80, 82, 88, 90. In some aspects, the thermal wires 100, 102, 104, 106 can be flexible heating cables or strips that are wrapped around the exterior of the fluid lines or embedded within the tubing material itself. The thermal wires 100, 102, 104, 106 can operate at relatively low temperatures to maintain the oil in a fluid state without overheating, and can be configured to provide uniform heat distribution along the length of each fluid line. In some cases, the thermal wires 100, 102, 104, 106 can include temperature sensors or thermostats that regulate the heating to maintain optimal oil viscosity for consistent flow rates. Each of the thermal wires 100, 102, 104, 106 can be powered by the electronics package housed in the housing 76. It is to be appreciated that each of the fluid lines 80, 82, 88, 90 can be considered part the oil distribution system identified above.

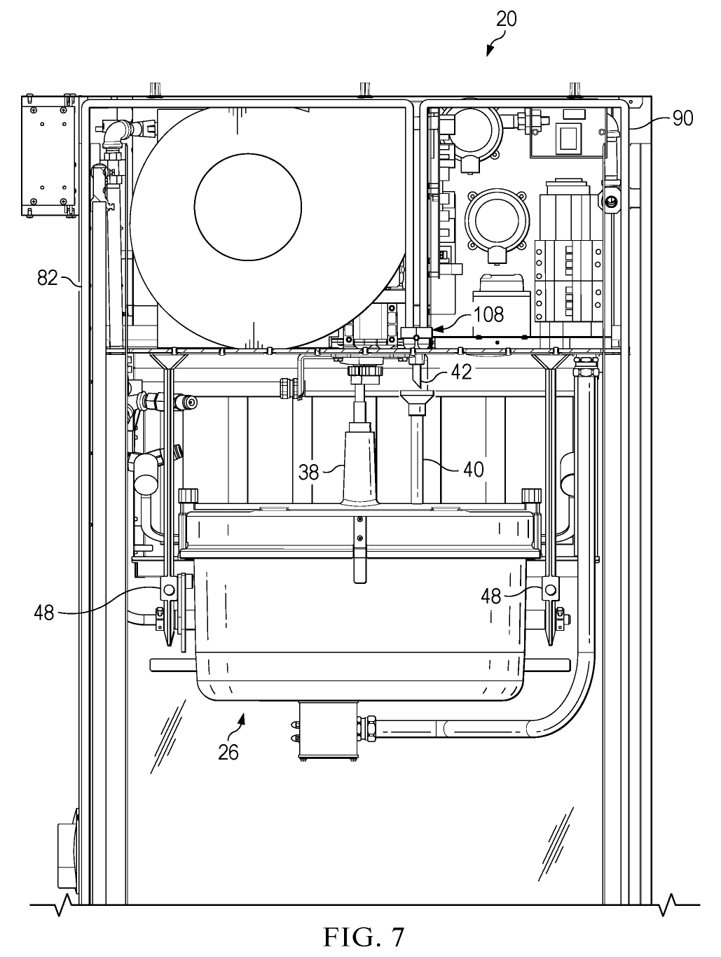

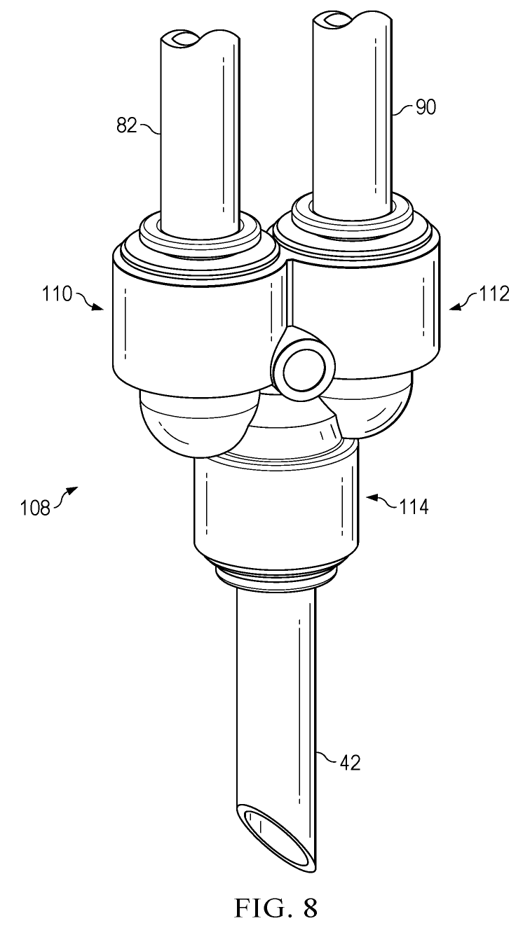

Referring now to FIG. 7, the fluid outlet lines 82, 90 from the first and second pumps 64, 66 can be routed along opposite sides of the housing 22 and towards the kettle 26. The fluid outlet lines 82, 90 can be routed through internal cavities of the housing 22 such that they are generally concealed. Each of the fluid outlet lines 82, 90 can be coupled with the dispensation tube 42 via a fluid junction 108 that allows the oil from either of the first or second oil containers 29a, 29b (via the fluid outlet lines 82, 90) to be directed to the dispensation tube 42. The fluid junction 108 is illustrated in FIG. 8 and is shown to include a first input port 110, a second input port 112, and an output port 114 that are in fluid communication with each other. The first input port 110 and the second input port 112 may be fluidly isolated from each other and positioned upstream of the output port 114, with both first and second input ports 110, 112 feeding into the output port 114 to allow for selective oil delivery from either fluid input port 110, 112 into the fluid output port 114.

The fluid outlet line 82 can be fluidly coupled with the first input port 110, the fluid outlet line 90 can be fluidly coupled with the second input port 112 and the output port 114 can be fluidly coupled with the dispensation tube 42. As such, when oil from the first container 29a is introduced into first input port 110 from the fluid outlet line 82, the oil is routed from the first input port 110, through the output port 114 and into the dispensation tube 42 for dispensation to the funnel 40. Conversely, when oil from the second container 29b is introduced into second input port 112 from the fluid outlet line 90, the oil is routed from the second input port 112, through the output port 114 and into the dispensation tube 42 for dispensation to the funnel 40. It is to be appreciated that each of the dispensation tube 42 and the fluid junction 108 can be considered part the oil distribution system.

Referring again to FIGS. 4 and 5, the pump assembly 62 can include a selector switch 118 that allows a user to select which of the first and second pumps 64, 66 are to be activated when the control system requests oil to be pumped into the kettle 26. The selector switch 118 can therefore allow a user to effectively select which of the first and second oil containers 29a, 29b provide oil to the kettle 26. For example, when the selector switch 118 is provided in a first position, and the control system requests oil, the first pump 64 is activated to supply oil from the first oil container 29a to the kettle 26. Conversely, when the selector switch 118 is in the second position and the control system requests oil, the second pump 66 can be activated to supply oil from the second oil container to the kettle 26.

It to be appreciated that even though the selector switch 118 is shown to be a rocker-type switch, any of a variety of suitable alternative selector switches are contemplated that can be configured to allow a user to selectively activate either of the first pump 64 or the second pump 66. Such alternative selector switches can include, but are not limited to, toggle switches, push-button switches, rotary switches, slide switches, membrane switches, capacitive touch switches, magnetic switches, or electronic switches controlled via software interfaces. Additionally, the selector switch 118 can be configured as a remote-controlled switch that allows selection via wireless communication, or as part of a digital control interface that integrates with the control panel 44 to provide visual indication of the selected pump status. In some instances, a graphical representation of a selector switch or a similar selection device can be displayed on the display 45 of the control panel 44 to allow a user to selectively activate either the first pump 64 or the second pump 66 from the control panel 44.

During the popcorn popping process, the control system can transmit a control signal to the pump assembly 62 that requests that oil be pumped to the kettle 26. This control signal can be generated automatically based on predetermined timing parameters programmed into the controller, or it can be initiated manually by the user through the control panel 44. The control signal can include specific parameters such as pump activation duration, flow rate requirements, and timing sequences that correspond to different popcorn recipes or batch sizes. In response to receiving the control signal, the pump assembly 62 can operate either the first or second pump 64, 66 based upon the position of the selector switch 118. The electronics package within the housing 76 can interpret the control signal and activate the appropriate pump while monitoring operational parameters such as pump pressure, flow rate, and electrical current draw to ensure proper operation. The pumping duration and amount of oil that is dispensed to the kettle 26 can be precisely controlled via the control signal, which can specify exact timing intervals or volumetric measurements to ensure consistent oil quantities for each batch. The control signal can be transmitted to the electronics package of the pump assembly 62 via a wired connection using standard electrical cables, or through wireless communication protocols such as Wi-Fi, Bluetooth, or proprietary radio frequency systems that allow for remote operation and monitoring capabilities.

In one embodiment, the first and second oil containers 29a, 29b can contain different types of oil that are suitable for popping different types of popcorn. For example, the first oil container 29a might contain canola oil that is specifically formulated for producing traditional theater-style popcorn, while the second oil container 29b might contain coconut oil that is preferred for gourmet-type popcorn applications . Different oils can also provide varying nutritional benefits, cooking temperatures, and flavor characteristics that complement specific popcorn varieties or customer preferences. In such an embodiment, the user is able to use the selector switch 118 to select the particular oil that is suitable for the specific type of popcorn that is being popped, allowing for versatile operation within a single machine. This dual-oil capability enables operators to offer multiple popcorn varieties without requiring separate equipment or manual oil changes between batches. The selector switch 118 provides immediate switching capability, allowing operators to change oil types between popping cycles based on customer demand or recipe requirements.

In another embodiment, the same oil might be utilized in both of the first and second oil containers 29a, 29b to provide redundancy and continuous service capability. In such an embodiment, the user is able to use the selector switch 118 to seamlessly transition from a depleted oil container to a full oil container, thus enabling the depleted oil container to be replaced without taking the popcorn machine 20 out of service. This configuration is particularly advantageous in high-volume commercial environments such as movie theaters, sports venues, or concession stands where continuous operation is important. When the controller or display 45 indicates that one oil container is running low, the operator can simply toggle the selector switch 118 to activate the pump associated with the full container, allowing uninterrupted popcorn production. The depleted container can then be safely removed and replaced with a fresh container during normal operation, eliminating downtime and ensuring consistent product availability.

It is to be appreciated that the support rack 50 and pump assembly 62 can effectively provide a standalone unit that is self-sufficient (with the exception of the control signal from the control system). The support rack 50 can provide dedicated compartments for housing the oil containers 29a, 29b with appropriately angled shelves 54, 58 to facilitate complete oil drainage, while the pump assembly 62 can include its own dedicated electronics package within the housing 76 for independent operation of the first and second pumps 64, 66. The oil distribution system can therefore be easily retrofit into an existing popcorn machine without requiring significant rewiring or reconfiguration of the existing machine infrastructure. The modular design allows the entire system, including the fluid lines 80, 82, 88, 90 with their associated thermal wires 100, 102, 104, 106, filters 86, 94, and couplers 84, 92, to be installed as a complete assembly with minimal integration requirements. The fluid junction 108 and dispensation tube 42 can be readily connected to existing kettle configurations, and the selector switch 118 can provides immediate operational control without complex programming or setup procedures. It is to be appreciated that although a popcorn machine is described herein, an oil distribution system according to the principles and features disclosed herein can be used on any of a variety of suitable alternative food machines that utilize cooking oil, including commercial fryers, automated cooking equipment, or other heated food preparation devices that require precise oil dispensing capabilities.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. An oil distribution system for a food machine, the oil distribution system comprising:
a first pump having a first inlet port and a first outlet port;
a second pump having a second inlet port and a second outlet port;
a first fluid inlet line fluidly coupled to the first inlet port and configured to fluidly couple to a first oil container;
a first fluid outlet line fluidly coupled to the first outlet port;
a second fluid inlet line fluidly coupled to the second inlet port and configured to fluidly couple to a second oil container;
a second fluid outlet line fluidly coupled to the second outlet port;
a fluid junction comprising:
a first input port fluidly coupled to the first fluid outlet line;
a second input port fluidly coupled to the second fluid outlet line; and
an output port in fluid communication with the first input port and the second input port; and
a selector switch configured to selectively activate either the first pump or the second pump, wherein:
activation of the first pump directs oil from the first fluid inlet line to the first input port of the fluid junction, and
activation of the second pump directs oil from the first fluid inlet line to the second input port to the output port of the fluid junction.

2. The oil distribution system of claim 1, further comprising a dispensation tube fluidly coupled to the output port of the fluid junction.

3. The oil distribution system of claim 2, further comprising a funnel positioned beneath the dispensation tube to receive oil from the dispensation tube.

4. The oil distribution system of claim 1, further comprising:
a first filter incorporated into the first fluid outlet line; and
a second filter incorporated into the second fluid outlet line.

5. The oil distribution system of claim 1, further comprising:
a first coupler at an end of the first fluid inlet line configured for releasable coupling with the first oil container; and
a second coupler at an end of the second fluid inlet line configured for releasable coupling with the second oil container.

6. The oil distribution system of claim 1, further comprising:
a first thermal wire associated with the first fluid outlet line; and
a second thermal wire associated with the second fluid outlet line.

7. The oil distribution system of claim 1, further comprising:
a first thermal wire associated with the first fluid inlet line; and
a first thermal wire associated with the second fluid inlet line.

8. The oil distribution system of claim 1, wherein the selector switch is a rocker switch.

9. The oil distribution system of claim 1, further comprising a housing that houses the first pump and the second pump.

10. The oil distribution system of claim 9, wherein the selector switch is mounted on the housing.

11. A popcorn machine, comprising:
a housing defining a popping chamber;
a kettle disposed in the popping chamber;
a storage compartment configured to house a first oil container and a second oil container;
a first pump fluidly coupled to the first oil container;
a second pump fluidly coupled to the second oil container;
a dispensation tube positioned to dispense oil into the kettle;
a fluid junction fluidly coupling the first pump and the second pump to the dispensation tube, the fluid junction having a first input port, a second input port, and an output port; and
a selector switch configured to selectively activate either the first pump or the second pump to dispense oil from the first oil container or the second oil container, respectively, to the kettle.

12. The popcorn machine of claim 11, further comprising a funnel extending from the kettle and providing a pathway therethrough that allows oil to be introduced into the kettle from the dispensation tube.

13. The popcorn machine of claim 12, wherein the dispensation tube is spaced from the funnel to allow the funnel and the kettle to pivot relative to the dispensation tube.

14. The popcorn machine of claim 11, further comprising a support rack positioned within the storage compartment, the support rack comprising:
an upper compartment configured to house the first oil container;
a lower compartment configured to house the second oil container;
an upper shelf within the upper compartment; and
a lower shelf within the lower compartment, wherein the upper shelf and the lower shelf are angled to facilitate drainage of oil from the first oil container and the second oil container.

15. The popcorn machine of claim 11, further comprising:
a first fluid inlet line fluidly coupling the first pump to the first oil container;
a second fluid inlet line fluidly coupling the second pump to the second oil container;
a first fluid outlet line fluidly coupling the first pump to the first input port of the fluid junction; and
a second fluid outlet line fluidly coupling the second pump to the second input port of the fluid junction.

16. The popcorn machine of claim 15, further comprising:
a first thermal wire associated with the first fluid inlet line;
a second thermal wire associated with the second fluid inlet line;
a third thermal wire associated with the first fluid outlet line; and
a fourth thermal wire associated with the second fluid outlet line.

17. The popcorn machine of claim 11, wherein the first oil container and the second oil container are bag-in-box type containers.

18. An oil distribution system for a popcorn machine, the oil distribution system comprising:
a fluid junction comprising:
a first input port configured to receive oil from a first pump;
a second input port configured to receive oil from a second pump; and
an output port in fluid communication with both the first input port and the second input port; and
a funnel spaced from the fluid junction and configured to provide a pathway that allows oil to be introduced into the funnel from the fluid junction, wherein:
the first input port and the second input port are fluidly isolated from each other and positioned upstream of the output port such that both the first input port and the second input port feed into the output port to allow for selective oil delivery from either the first input port or the second input port into the output port, and
the fluid junction is spaced from the funnel to allow the funnel to move relative to the fluid junction.

19. The oil distribution system of claim 18, further comprising a dispensation tube fluidly coupled to the output port and configured to dispense oil into the funnel.

20. The oil distribution system of claim 18, wherein the fluid junction is configured to deliver pressurized oil to the funnel and the funnel is configured to deliver non-pressurized fluid to an underlying kettle bowl.
